(19) United States
(12) Patent Application Publication
(10) Pub. No.: US 2015/0336507 A1
(43) Pub. Date: Nov. 26, 2015

(54) Horn System

(71) Applicants: William Collins, Elko, NV (US); Ward Anderson, Elko, NV (US)

(72) Inventors: William Collins, Elko, NV (US); Ward Anderson, Elko, NV (US)

(21) Appl. No.: 14/721,867

(22) Filed: May 26, 2015

Related U.S. Application Data
(60) Provisional application No. 62/002,485, filed on May 23, 2014.

(51) Int. Cl. B60Q 5/00

(52) U.S. Cl. CPC B60Q 5/005

(57) ABSTRACT

The present invention provides a horn system configured to electrically activate a vehicle's horn based upon the operational state of the vehicle. The horn system is configured to detect a shift from one gear to another gear on a gearbox of a vehicle, wherein a switch is actuated to transmit an electrical signal that is indicative of a selected transmission gear. A microprocessor having an electronic module is configured to determine the selected transmission gear and sound a horn of a vehicle to indicate to others of vehicle movement to ensure safety. The microprocessor transmits a signal to the horn to produce one honk when the vehicle is activated. The microprocessor transmits a signal to sound the horn twice if the gearbox is shifted into drive. The microprocessor transmits a signal to sound the horn thrice if the gearbox is shifted into reverse.

### CROSS REFERENCE TO RELATED APPLICATION

This application claims the benefit of U.S. Provisional Application No. 62/002,485 filed on May 23, 2014. The above identified patent application is herein incorporated by reference in its entirety to provide continuity of disclosure.

### FIELD OF THE INVENTION

The present invention relates to vehicle horn assemblies. More specifically, the present invention relates to a vehicle horn system that is electrically connected to a horn of a car and configured to actuate the horn when the gearbox of a vehicle is activated or shifted into drive and reverse.

### BACKGROUND OF THE INVENTION

The Mine Safety and Health Administration (MHSA) is an agency of the United States Department of Labor, which under the provisions of the Federal Mine Safety and Health Act of 1977, enforces the compliance with mandatory safety and health standards. In this way, the MHSA aims to eliminate fatal accidents, reduce the frequency and severity of nonfatal accidents, minimize health hazards, and promote improved safety and health conditions in the nation's mines. One of the regulations enforced by the MHSA is in regards to the operation of vehicles in working mine sites to ensure the safety of workers at the site.

Vehicles, under the regulations, are required to maintain manually operated horns or other audible warning devices in functional condition. Furthermore, vehicle operators are required to sound the horn once before starting the vehicle. Before driving forward, vehicle operators are also required to sound the horn twice to provide ample notice to any workers within the vicinity. If the vehicle is shifted into reverse, vehicle operators are mandated to sound the horn three times. These precautions are enforced to ensure the safety of workers at the site, however, even the most law abiding individuals may occasionally forget to sound the horn before operating a vehicle. Therefore, there exists a need for a horn system that electronically connects a vehicle horn to a gearbox of a vehicle to electronically actuate the horn without an individual having to manually operate the horn.

Devices have been disclosed in the prior art that relate to vehicle audible systems and horns. These include devices that have been patented and published in patent application publications. Some of the devices in the prior art relate to vehicle back-up systems and warning systems relating to the status of the vehicle's operational state. These devices, however, fail to provide a horn system that sounds the horn an appropriate number of times upon activating the gearbox, shifting the gearbox into drive, and shifting the gearbox into reverse.

The present invention provides a horn system configured to electrically activate a vehicle's horn based upon the operational state of the vehicle. The horn system is configured to detect a shift from gear to gear, wherein a switch is configured to transmit an electrical signal that is indicative of a selected transmission gear. A microprocessor having an electronic module is configured to detect the selected transmission gear based on the resistance value of the electrical signal and actuate a horn of a vehicle to indicate to others whether the vehicle is shifted into drive or reverse. The microprocessor transmits a signal to the horn to produce one honk when the gearbox is activated. Upon detecting a signal from the switch that the vehicle is shifted into drive, the microprocessor transmits a signal to the horn to emit two honks. If the signal from the switch indicates that the vehicle has been shifted into reverse, the microprocessor transmits a signal to the horn to emit three honks.

It is therefore submitted that the present invention is substantially divergent in design elements from the prior art, and consequently it is clear that there is a need in the art for an improvement to vehicle horn systems. In this regard, the instant invention substantially fulfills these needs.

### SUMMARY OF THE INVENTION

In view of the foregoing disadvantages inherent in the known types of horn systems now present in the prior art, the present invention provides a horn system wherein the same can be utilized for alerting others of a moving vehicle to prevent potential accidents causing harm and damage.

It is therefore an object of the invention to provide a new and improved horn system that has all of the advantages of the prior art and none of the disadvantages.

Another object of the present invention is to provide a new and improved horn system comprising a switch connected to a gear selector of a gearbox of a vehicle, wherein the manual operation of the gear selector is configured to actuate the switch and prompt the switch to transmit a signal to a microprocessor.

Yet another object of the present invention is to provide a new and improved horn system, wherein the signal is configured to be indicative of a selected transmission gear.

Still yet another object of the present invention is to provide a new and improved horn system, wherein the microprocessor is electrically connected to a horn configured to produce at least one honk based on the signal.

A further object of the present invention is to provide a new and improved horn system, wherein the switch encodes the signal using resistive multiplex to indicate the selected transmission gear.

An additional object of the present invention is to provide a new and improved horn system, wherein the microprocessor includes an electrical module that is configured to decode the signal and determine the selected transmission gear.

Yet a further object of the present invention is to provide a new and improved horn system, wherein the microprocessor is configured to transmit a signal to the horn to produce one honk when the vehicle is activated.

Another object of the present invention is to provide a new and improved horn system, wherein the microprocessor is configured to transmit a signal to the horn to produce two honks when the gear selector is shifted into drive.

Yet another object of the present invention is provide a new and improved horn system, wherein the microprocessor is configured to transmit a signal to the horn to produce three honks when the gear selector is shifted into reverse.

Still yet another object of the present invention is to provide a new and improved horn system wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawing wherein like numeral annotations are provided throughout.

FIG. 1 shows a schematic diagram of the horn system of the present invention.

### DETAILED DESCRIPTION OF THE INVENTION

Reference is made herein to the attached drawings. Like reference numerals are used throughout the drawings to depict like or similar elements of the horn system. For the purposes of presenting a brief and clear description of the present invention, the preferred embodiment will be discussed as used to activate a vehicle's horn to warn others of a moving vehicle. The figures are intended for representative purposes only and should not be considered to be limiting in any respect.

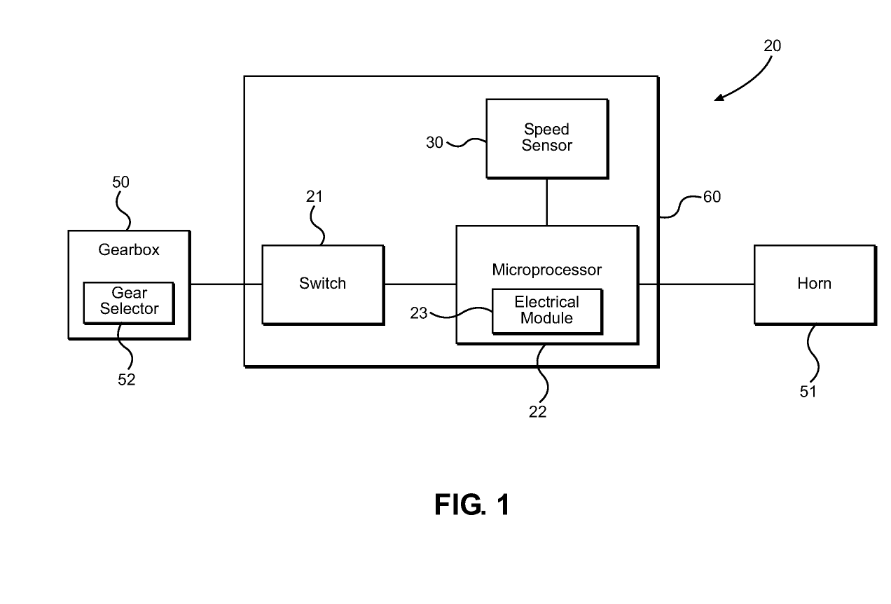

Referring now to FIG. 1, there is shown a schematic diagram of the horn system 20. The horn system 20 is configured to electrically activate a vehicle's horn based upon the operational state of the vehicle. In this way, other people within the vicinity are warned of moving vehicles and prevents an operator from failing to sound the horn which can result in bodily injury or damage. Generally, the horn system 20 is electrically connected to a gearbox 50 of a vehicle. The horn system 20 is configured to detect a shift from one gear to another gear, wherein a switch 21 is actuated to transmit an electrical signal that is indicative of a selected transmission gear. A microprocessor 22 having an electronic module 23 is configured to decode the selected transmission gear based on the resistance value of the electrical signal and actuate a horn 51 of a vehicle to indicate to others whether the vehicle is shifted into drive or reverse.

The gearbox 50 of a vehicle includes a gear selector 51 that is accessible to a vehicle operator, wherein the operator manually selects a desired gear using the gear selector. The manual operation of the gear selector 51 is configured to actuate the switch 21. The switch 21 uses potentiometric output to resistive multiplex an electrical signal, such that each change in gear position results in electrical contact through a different resistor. By resistive multiplexing the functions of the switch 21 and varying a transmitted electrical signal, the switch 21 transmits an electrical signal that is indicative of a selected transmission gear.

The switch 21 is in electrical communication with a microprocessor 22 having an electrical module 23. Upon receiving an electrical signal from the switch 21, the electrical module 23 is configured to decode the signal and determine the selected gear position. Preferably, the switch 21 is configured to transmit an electrical signal that is indicative of whether the vehicle was shifted into drive or reverse. Furthermore, when the vehicle is activated, i.e., the gearbox 50 is activated, the switch 21 is configured to transmit a signal to the microprocessor 22 indicating that the vehicle has been activated. Preferably, the electrical module 23 can use a ten-bit analog to digital converter to decode the electrical signal into a selected gear position, however other suitable modules are likewise contemplated.

Upon decoding, the microprocessor 22 transmits another electrical signal to the horn 51 of the vehicle. The horn 51 includes an electromagnet that is used to actuate a steel diaphragm. As the current is applied to the electromagnet, the diaphragm moves towards the magnet. When the diaphragm is moved to its maximum point toward the magnet, a connection is released, temporarily disconnecting the current and allowing the steel diaphragm to relax. Once this happens, the electromagnet applies current again moving the diaphragm toward the magnet. This cycle repeats evenly and causes the diaphragm to oscillate back and forth producing the sound of the car horn. In other embodiments, a flasher relay, or other suitable relays are alternatively used to produce sounds through the horn 51. These alterations and modifications are deemed within the scope and spirit of the present disclosure and are likewise contemplated.

The microprocessor 22 is configured to transmit a signal to the horn 51 to produce one honk when the vehicle and gearbox 50 is activated. Furthermore, upon decoding a signal from the switch 21 that the gear selector 51 was shifted into drive, the microprocessor 22 transmits a signal to the horn 51 to emit two honks. If the signal from the switch 21 indicates that the gear selector 51 has been shifted into reverse, the microprocessor 22 transmits a signal to the horn 51 to emit three honks. In this way, an operator can notify to others that the vehicle is about to be in movement and the direction the vehicle will be moving.

In some embodiments, the horn system 20 further includes a speed sensor 30. The speed sensor 30 is configured to detect whether the vehicle is moving or stationary. Upon detecting that the vehicle is moving, the speed sensor transmits a signal to the microprocessor 22 to transmit to the horn 51 to product at least one honk. When the vehicle is moving forward, the horn 51 is configured to sound two honks, while when the vehicle is moving in reverse, the horn 51 is configured to sound three honks. In this way, people surrounding the vehicle may be notified that the vehicle is in movement to provide further warning to prevent accidents that may cause harm or damage.

The horn system 20 is preferably enclosed within a junction box 60. Preferably, the junction box 60 is composed of a waterproof and noncorrosive material, however, other suitable material are likewise contemplated. The junction box 60 is preferably square or rectangular in shape, however other shapes and sizes are suitable to enclose the horn system 20.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A horn system, comprising:
a switch connected to a gear selector of a gearbox of a vehicle;
wherein manual operation of said gear selector is configured to actuate said switch and prompt transmission of a signal from said switch to a microprocessor;
said signal is configured to be indicative of a selected transmission gear;
said microprocessor is electrically connected to a horn configured to produce at least one honk based on said signal.

2. The horn system of claim 1, wherein said switch encodes said signal using resistive multiplexing to indicate said selected transmission gear.

3. The horn system of claim 1, wherein:
said microprocessor includes an electrical module;
wherein said electrical module is configured to decode said signal from said switch and determine said selected transmission gear.

4. The horn system of claim 1, wherein said switch is further configured to transmit a signal to said microprocessor when said gearbox is activated.

5. The horn system of claim 1, wherein said microprocessor is configured to transmit a signal to said horn to produce one honk when said gearbox is activated.

6. The horn system of claim 1, wherein said microprocessor is configured to transmit a signal to said horn to produce two honks when said gear selector is shifted into drive.

7. The horn system of claim 1, wherein said microprocessor is configured to transmit a signal to said horn to produce three honks when said gear selector is shifted into reverse.

8. The horn system of claim 1, further comprising a speed sensor;
wherein said speed sensor is configured to transmit a signal to said microprocessor to transmit a signal to said horn to produce said at least one honk when said vehicle is moving.

9. The horn system of claim 1, further comprising a junction box;
wherein said junction box is configured to support and enclose said switch and said microprocessor.

10. A horn system, comprising:
a junction box including a switch, a microprocessor, and a speed sensor;
wherein said switch is electrically coupled to a gear selector of a gearbox of a vehicle;
wherein manual operation of said gear selector is configured to actuate said switch and prompt transmission of a signal from said switch to a microprocessor;
said microprocessor is electrically connected to a horn configured to produce at least one honk based on said signal.
